(19) United States
(12) Patent Application Publication
(10) Pub. No.: US 2004/0251308 A1
(43) Pub. Date: Dec. 16, 2004

(54) Dual format medium

(76) Inventors: Tue Nguyen, Fremont, CA (US); Larry Clopp, Pleasanton, CA (US); Minoru Tomijima, Menlo Park, CA (US)

Correspondence Address: Tue Nguyen, 40737 Encyclopedia Circle, Fremont, CA, 94538, US

(21) Appl. No.: 10/459,958

(22) Filed: Jun. 12, 2003

(51) Int. Cl. G06K 19/00

(52) U.S. Cl. 235/487

(57) ABSTRACT

A dual format medium can receive and store information in two formats, a printed text format and an electronic format for machine recognition. The dual format medium includes a printable surface for showing the text in a visual format and a data storage section for receiving and storing essentially the same information in an electronic format. The dual format medium allows the rapid and accurate processing of information transfer.

### FIELD OF THE INVENTION

This invention relates to dual format media that can be understood by both human and machine. Specifically, this invention relates to sheets of paper containing information in two formats, a visual format for human recognition and a binary format for machine recognition.

### BACKGROUND OF THE INVENTION

Traditionally paper has allowed information to be distributed widely and cost effectively. With the advent of electronic appliances, such as PC's, PDA's, etc., and the Internet has made it easy for information to be transmitted, stored and retrieved. Thus, these are currently two widely used formats for information transfer, a visual format such as printed text and graphics for human recognition, and an electronic or binary format such as computer-generated text or graphics files for machine recognition.

The information in these two formats is not easily convertible without the aid of machines and software. A binary file consists of zeros and ones, and no one can understand it without translation software and a display. A printed text cannot be understood by machine without a scanner to digitalize the text and optical recognition software to convert the bitmap graphics into a binary electronic file. Binary files can be printed easily and accurately, but converting a scanned text file into electronic format is often fraught with inaccuracies and carries an equipment and software cost.

The electronic format can be either analog or digital. The analog coded files store information as different levels of signal strength. The digital coded files store information in a series of zeros and ones. Examples for this are magnetic cassette or videotapes or magnetic floppy or hard disks. The surface of the tape or disk is coated with a layer of magnetic material, and by magnetizing it, information can be stored in the magnetic medium. Analog information can be stored by the strength of the magnetic particles whereas digital information can be stored by the particles being magnetized or not. Another example is the CD disk. The surface of the thick vinyl CD disk is coated with a translucent material. By “burning” this layer with a laser beam, the coating becomes opaque. The laser beam is also used to “read” the information encoded in the optical coating by the difference in the translucent and opaque properties. In general, the magnetic or CD disk can contain a lot of information, but a human cannot understand this information because only a lot of zeros and ones (magnetized or non-magnetized areas in a magnetic disk, or a transparent or opaque areas in a CD disk) are stored. In the same token human readable and electronic formats are not compatible and neither stored nor displayed in the same medium.

There are some cases where visual and electronic informations are stored in one medium. There are some cards and tickets having printed information and a magnetic strip to store electronic information. The tickets with magnetic strips are normally used in various transportation systems, such as airlines, subways and railways to facilitate the passengers going through the turnstiles. The ticket is generally a paper card having a magnetic strip on the back side with the front side having various pre-printed data such as the company name and travel data such as the departure and arrival places, date and time. When the ticket is inserted into the reader, the ticket data is read from the magnetic strip. The information stored in the magnetic strip is not identical to the information printed on the ticket. The two pieces of information are independent and meant to satisfy different requirements. For example, the name of the company is printed on the ticket for the human recognition, but this information may not be needed in the magnetic strip. The magnetic strip may contain some statistical or some confidential information that is not printed on the ticket.

Credit cards and access control cards also have printed information and a magnetic strip on the back of them. The magnetic strip is made of similar material as the magnetic tape, a coating of magnetic oxides. Reading is done by an inductive head in the card reader. Printed information normally includes the company name, the bank name and other information such as the holder name and access number. The data stored in the magnetic strip normally contains the access information and can also be used to validate or authenticate the user. Again information contained in these two formats is independent and perhaps deliberately not identical.

### SUMMARY OF THE INVENTION

The present invention discloses a dual format medium such as a sheet of paper for containing essentially the same information in two formats, a visual format for human readability and an electronic format for machine recognition. The dual format medium serves to transmit information effectively and accurately.

The dual format medium comprises a printable surface for displaying information for visual recognition and a data storage section for receiving and storing essentially the same information in an electronic format for machine recognition. The dual format medium allows human understanding without the need of a display and also allows accurate machine processing without the need of translation equipment and software.

The data storage section of the disclosed dual format medium can be a coating of magnetic material, a coating of optical material, or a coating of magneto-optical material, or an opto-chemical material. The printable surface of the dual format medium can be used for printing in a printer, a copier, a fax machine, a POS machine or an electronic typewriter.

The present invention also discloses a dual transmission method and equipment to transfer both visual and electronic information concurrently.

### BRIEF DESCRIPTION OF THE DRAWINGS

FIG. 1 shows an embodiment of the dual format medium according to the present invention.

FIG. 2 shows another embodiment of the dual format medium according to the present invention.

### DETAILED DESCRIPTION OF THE INVENTION

The present invention discloses a dual format medium such as a sheet of paper for containing essentially the same information in two formats, a printed format for human recognition and an electronic format for machine recognition.

The dual format medium is preferably a thin flexible sheet of material such as paper or transparency. The disclosed dual format medium is comprised of a printable surface for showing the information in a human readable format and a data storage section for receiving and storing essentially the same information in an electronic format for machine recognition. The dual format medium allows a conveyance of machine readable information on a traditional printed piece of paper.

The dual format medium allows the visual information to be distributed quickly and without error. Without the electronic format, the visual printed information will have to be digitalized by a scanner. Then the digitalized information must be converted to an electronic text file by optical character recognition (OCR) software. The conversion may not be perfect due to many possible approximations during the OCR process. The printed information may be damaged or smeared. The scanning might not pick up the right contrast or brightness. The OCR software might not translate properly, especially for some un-common characters. In addition, the formatting of the printed text information is extremely difficult to preserve. Furthermore, the conversion of the graphic information is even more difficult and normally the graphic information is kept in the digitalized format such as a bitmap format and not as the original electronic format such as a drawing, an x-y plot or a vector files.

The disclosed dual format medium provides the information as a printed text on the printable surface and its copy is stored in the electronic format in the data storage section. The printed text allows for the visual recognition and the electronic format allows an accurate reading of the same information, either in text files or in graphic files, up-loadable, for example, to a PC.

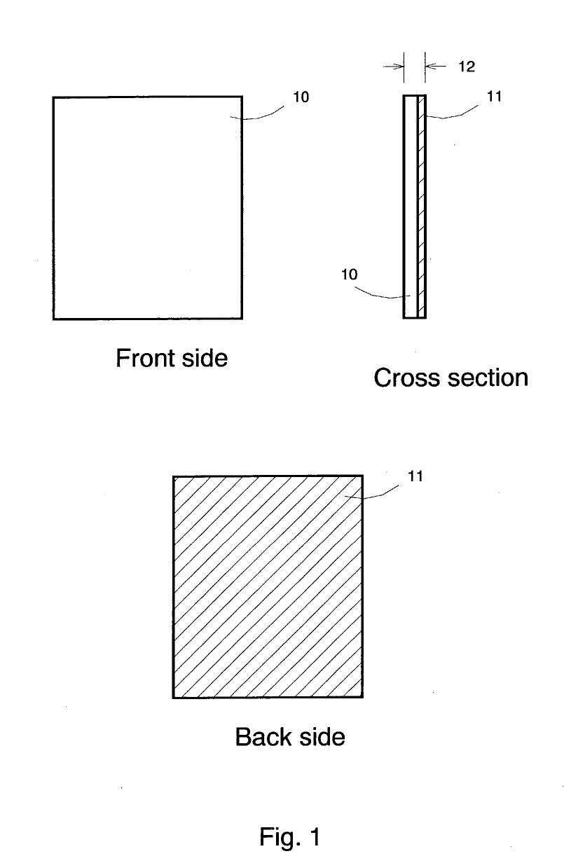

FIG. 1 shows an embodiment of the dual format medium according to the present invention. The dual format medium is a thin flexible sheet of paper having a thickness 12, preferable between 0.1 mm to 1 mm. The front side of the paper comprises a printable surface 10 to display visual information. The backside of the paper is the data storage section 11, covering the whole backside of the paper. In other aspect of the invention, the data storage section can be in the front side and overlapping with the printable surface because the printable surface and the data storage section may not interfere with each other.

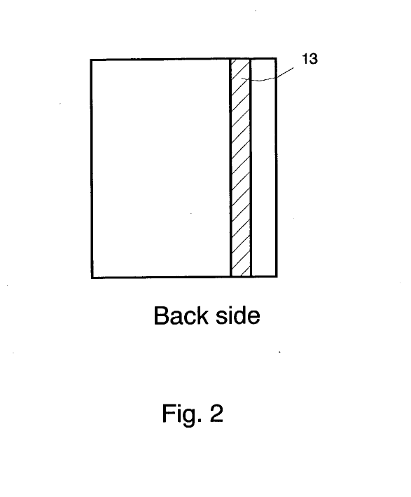

FIG. 2 shows another embodiment of the dual format medium according to the present invention wherein the data storage section is a stripe 13.

The data storage section of the disclosed dual format medium can be a coating of magnetic material. One side of the dual format medium is a regular printable surface for text or graphics or any other information (such as Braille characters for the visually impaired persons) suitable for human recognition. The coating of the magnetic material can be on the same side of the printable surface. The magnetic coating can cover different areas to prevent overlap. The magnetic coating is preferably on the verso of the printable surface, covering the whole surface or just a strip of coating. The coating of the magnetic material on the paper represents a data storage section for receiving and storing essentially the same information in an electronic format for machine recognition. The information can be stored in the magnetic coating and can be read by a magnetic reader comprising a magnetic head and associated electronic components. The electronic format can further comprise a security code to prevent the invalid modification of the printed text information. The magnetic stripe, together with magnetic reader technology are currently readily available. For example, see West et al., U.S. Pat. No. 5,714,747, Berson, U.S. Pat. No. 5,932,870, and Momose et al., U.S. Pat. No. 6,171,002, hereby incorporated by reference.

The magnetic material in the magnetic strip or surface can be of different colors. Different colors of magnetic material allow the dual format medium or paper to be cosmetically pleasing or the printed text or graphics to be distinguishable. The magnetic material is preferably of light color, or similar color as the medium or paper surface. Color magnetic particles are available on the market such as from Newco, Inc. (web page www.newcoinc.com), hereby incorporated by reference.

The data storage section of the disclosed dual format medium can be a coating of optical material. The optical material is preferably composed of a photosensitive dye. The dye is normally translucent and light can shine through it. The photosensitive dye can turn opaque if a focused light (such as a laser beam) of a particular frequency and intensity shines on the photosensitive dye material. The translucent and opaque property of the photosensitive dye layer generates a digital pattern to store the information. A reflective coating such as aluminum can be further applied to allow the reading light source to reflect (if the area is translucent) or diffused (if the area is opaque). The reading light source can be a laser beam with a weak intensity or a different frequency not to damage the photosensitive optical layer. The photosensitive optical materials are currently used expensively on compact disk (CD ROM and RW) coating. For example, see Tanako et al., U.S. Pat. No. 5,297,132, Tamura, U.S. Pat. No. 5,978,348, Dinnocenzo et al., U.S. Pat. No. 6,569,600, and Hayashida et al., U.S. Pat. No. 6,576,320, hereby incorporated by reference.

The data storage section of the disclosed dual format medium can also be a coating of magneto-optical material. For example, see Farnsworth et al., U.S. Pat. No. 5,101,385, and Miyake, U.S. Pat. No. 6,111,822, hereby incorporated by reference. The printable surface of the dual format medium can be used for printing in a printer, a copier, a fax machine, a POS machine or an electronic typewriter.

The information contained in the disclosed dual format medium is preferably transmitted through remote communication equipment such as a dual format fax machine. The dual format fax machine can be a combination of a standard fax machine (to print the information onto the printable surface of the dual format medium) and a magnetic reader or an optical reader (to receive and store the information in electronic format onto the data storage section of the dual format medium). By having the dual transmission capability, not only the information can be received and stored with the same accuracy as the original, but also additional information, for example, color graphics, voice, etc., can be added

The transmitted information can be up-loaded to a PC without the expensive and cumbersome OCR process. After modification, the information can be dually transmitted back to the sender, or can be transmitted to another recipient, or can be stored at the receiving party. Text transmittal can be benefited from this dual transmission due to the ease of up-loading to a PC. Graphic transmittal is benefited even more from this dual transmission. Sending graphic files through FAX often loses significant amount of information. Scanning before sending already degrades the quality of the graphic files, but re-scanning at the receiving end degrades the quality even further. Furthermore, some drawing files such as a CAD file or a x-y plot file cannot be reconstructed faithfully by FAX transmission. A typical CAD file contains significant amount of dimensions so that the part can be made. The dimensioning is time-consuming and has to be completed without missing dimensions information. Dual transmission capability will allow the receipt of the dimensioning requirements by the receiving party to reconstruct the CAD files exactly as the original from the sender. Thus, all dimensions or only the missing dimension can be read from the CAD files included in the dual format medium.

The disclosed dual format medium can also be incorporated into other office equipment, such as a copier, printer, electronic typewriter, POS machine, scanner, and even a hand-held scanner for sale receipts and business cards, especially in the Local Area Network environment.

The novelty in this invention also lies in the recognition that the paper medium is inexpensive, ubiquitous, disposable, and recyclable. Adding the machine readable capability to it enhances the usability of paper as the best and least expensive conveyance of information. It is also conceived as a temporary receiver and storage medium of information and an easy means to up-load information into a PC or PDA.

What is claimed is:

1. A dual format medium for containing information in two formats, comprising
a printable surface for displaying the information in a visual format for human recognition; and
a data storage section for receiving and storing essentially the same information in an electronic format for machine recognition,
wherein the dual format medium allows human understanding without the need of displaying machine and also allows accurate machine processing without the need of translation equipment.

2. A dual format medium as in claim 1 wherein the medium is a flexible sheet of material.

3. A dual format medium as in claim 1 wherein the medium is a flexible sheet of paper.

4. A dual format medium as in claim 1 wherein the printable surface can be used for printing in a printer, a copier, a fax machine or a typewriter.

5. A dual format medium as in claim 1 wherein the data storage section comprises a magnetic surface or stripe.

6. A dual format medium as in claim 1 wherein the data storage section comprises a magnetic surface or stripe on the opposite side of the printable surface.

7. A dual format medium as in claim 5 wherein the magnetic material in the magnetic stripe or surface comprises a light color magnetic material.

8. A dual format medium as in claim 1 wherein the data storage section can be used for receiving or reading the information in a magnetic reader system.

9. A dual format medium as in claim 1 wherein the data storage section comprises an optical coating surface or stripe.

10. A dual format medium as in claim 1 wherein the data storage section comprises an optical surface or stripe on the opposite side of the printable surface.

11. A dual format medium as in claim 1 wherein the data storage section can be used for receiving or reading the information in an optical reader system.

12. A dual format medium as in claim 1 wherein the data storage section comprises an magneto-optical coating surface or stripe.

13. A dual format medium as in claim 1 wherein the information stored in the electronic format further comprises a security code to prevent unauthorized modification.

14. A dual format medium as in claim 1 wherein the information is represented in a text format with the visual format being the printed text and the electronic format being a binary represented text file to allow transfer the text directly to a computer without the need for optical character recognition.

15. A dual format medium as in claim 1 wherein the information is represented in a graphic format with the visual format being the printed image, and the electronic format being a binary represented drawing file to allow transfer the drawing directly to a computer.

16. A dual format medium as in claim 1 wherein the information is represented in a graphic format with the visual format being the printed image, and the electronic format being a binary represented drawing file to allow accurate measurements of the image dimensions.

17. A dual format medium as in claim 1 wherein the dual format medium is a business card.

18. A dual format medium as in claim 1 wherein the dual format medium is a sale receipt.

19. A dual format medium for remotely receiving and sending information in two formats, comprising
a printable surface for displaying the information in a visual format for human recognition, the printable surface capable of receiving the information from a printing machine, and capable of sending the information from a scanning machine; and
a data storage section for receiving and storing essentially the same information in an electronic format for machine recognition, the data storage section capable of receiving and sending the information with an electronic communication device,
wherein the information is receiving and sending from and to a remote location through a communication equipment.

20. A method to remotely receiving and sending information in two formats, comprising
receiving and sending information in a visual format for human recognition; and
receiving and sending essentially the same information in an electronic format for machine recognition.
